(19) United States
(12) Patent Application Publication
(10) Pub. No.: US 2004/0205020 A1
(43) Pub. Date: Oct. 14, 2004

(54) Sharesloan

(76) Inventor: Ibrahim Halawi, Sterling, VA (US)

Correspondence Address: Merek, Blackmon & Voorhees, LLC, 673 S. Washington St., Alexandria, VA, 22314, US

(21) Appl. No.: 10/836,209

(22) Filed: May 3, 2004

Related U.S. Application Data
(63) Continuation-in-part of application No. 09/492,797, filed on Jan. 28, 2000, now abandoned.

(51) Int. Cl. G06F 17/60

(52) U.S. Cl. 705/38

(57) ABSTRACT

A system and a method of financing the purchase of real estate property based on shares, owned by two or more parties proportional to their contribution. The Sale Price “SP” of a property is converted into a specific number of shares “N”, divided between both Lender “LS” and Borrower “BS” proportional to their contribution. The Borrower can increase his shares and thus his equity in the property by purchasing Lender's shares from the Lender's shares over the loan term subject to annual profit rate through regular, periodic payments and/or through additional payments/investments. The Lender loan amount “L” is converted into a definite number of shares “LS” as well and amortized based on shares over the loan term. A regular Payment “Rb” equals the value of one share “SV” which determines the value of one share. The borrower makes regular payment “Rb” consisting of two portions. One portion goes towards “R” the lender profit on his capital, and the other portion “b” goes towards the borrower to purchase shares “n” from the lender and decrease the lender's shares.

This is a continuation in part of application Ser. No. 09/493,797 filed Jan. 28, 2000, which is hereby incorporated by reference.

### FIELD OF THE INVENTION

This invention relates to a Real Estate Purchase and Loan Repayment process (the Program) structured based on shares owned by the lender and the borrower proportionally to their loan original (and continuing) contribution taking in consideration all aspects of security, protection, penalties and all related issues for the benefit of both parties, lender and borrower as shares' holders/investors.

### BACKGROUND OF THE INVENTION/PROGRAM

In Real Estate Purchase, a Borrower usually enters into a loan agreement with lending institution to make a purchase, and a Lender enter into loan agreements to make a profit. The profit that the lender makes is derived from the finance charges or interest ONLY. In some cultures, the charging of “interest” is not allowed or not desirable.

The interest charged (“profit”) is only valid when charged in exchange for a good or service, etc. It's sometimes called “occupancy fee” or “usage fee”, and in the current invention it is the lender's profit on his shares.

A Lender desires to loan money and maintain security in the loaned funds. The loan amount is limited by the borrower's income, assets, liabilities as well as the amount of down payment. (Thus, if the borrower's income is increased, the borrower can buy more shares from the lender and pay off his loan faster, which the lender desires too).

The present invention will extend the profit of the lender from the benefit of interest payment ONLY into an additional amount of sharing equity with the borrowers when a sale or refinance takes place.

The invention encourages the borrower to put more money as down payment, invests in his own property and offers him relieve from any stress he might be exposed to later, through unexpected personal financial problems.

Therefore a borrower would benefit by basing his loan on shares and by buying more lender's shares to accelerate his buying out the loan.

When a borrower stops making payment, the lender may purchase back shares from the borrower's shares at the share's original price, up to a certain extent from the borrower's shares in the grace period agreed to with the lender from the outset.

In home selling, the assets will be distributed proportionally based on the shares owned by each party and the lender can or may make additional profit (Equity sharing).

Additionally, there are other reasons that such an equity based financial arrangement might be desirable:

Islamic finance rules and regulations (called “Shari' a”) prohibits paying interest money on loaned money, based on the principle money is not allowed to grow up by itself without efforts or risk to gain and loose concept and money (loan) can not be purchased by more money (loan+interest).

Islamic “Shari' a” highly recommends setting up a grace period when dealing with loans based on “Qora˜nic versus” to ease the hardship situation upon borrowers when they need to.

Islamic “Shari' a” highly recommends limiting the borrower liability and informing the borrower from the outset of the terms and limitations to prevent unacceptable, hidden potential penalties that might otherwise occurs.

### OBJECTS OF THE INVENTION

There are a, lot of borrowers that prefer to pay as little down payment as possible (0-3-5%), and to use their cash to invest in savings accounts bearing interest, or in the stock market, or in any other secure investment available. This allows the borrower to use their capital to generate investment profits, and to liquidate their capital quickly when they need to, responding to their financial obligations to be met such as paying their mortgage, preventing lenders' foreclosure to securing their assets such as the original and additional payment (investment) from any loss.

When interest rates are high, the total interest amount is high which lenders like, but risk is high too, which lenders dislike. However, but when interest rates are low, the interest amount is also low which lenders dislike since when a home sale takes place, lenders will receive only their loan balance.

One object of this invention is to allow the borrower to invest more money in his own property as down payment with peace of mind and to decrease his monthly payment without exposing his investment to foreclosure, a risk he may face if any potential personal financial problem arises pushing him to stop making payment. By using the grace period as cushion agreed to from the outset between the borrower and the lender.

In this invention all kinds of safety precautions may be taken to secure both the Lender and the borrower.

Lenders usually are satisfied by making money from the monthly interest payment only. In this invention, the “Shares loan” Program will offer the lender of a second source of making money by sharing the equity built up in the property. When a home's sale takes place, their shares have accumulated profit—which cannot usury, since it is equity based—as an opportunity for the lender to make money.

Also Lenders may have less risk from market fluctuation interest rate and still can make money by purchasing shares from the borrowers in the grace period at the original price “SV”, which accumulates profit not usury.

In the evaluation of loan repayment for residential mortgage, lenders like to assess two factors:

Borrower's affordability (income versus monthly payment) and

Underlying collateral value in case of foreclosure and resale.

House prices increase minimally as a result of inflation, as well as against further inflation as labor and building materials prices always go up, in addition land cost appreciate based on location, supply, demand, infrastructure put in place . . . as well as against further inflation.

Conventional fixed mortgage programs guarantee fixed payments to the lenders who are exposed to the interest rate variation risk over the life of the loans. Whereas ARMs (Adjustable Rate Mortgage) programs partially guarantee financial returns but expose the borrowers to unknown future mortgage obligations and sometimes its unaffordable.

The certainty in payment for the borrowers through fixed rate conventional mortgage means uncertainty for the lenders or interest rate risk. And certainty for the lenders against interest rate risk (through ARMs) means uncertainty in payment for the borrowers. In the majority of loans, lenders have the ability to impose additional penalties and payments on a defaulting borrower. When interest rates sink, the borrower may refinance his mortgage loan in the current market interest rate of his own election. The lender has no other choice or any other source of profit and he may loose the borrower to another lender.

“Shares Loan” PROGRAM according to the present invention permits:

i—The borrower to enjoy lower fixed payments throughout the life of loan.

ii—If home sale takes place, the lender will have more than the balance amount and will profit from the equity built up in his shares.

iii—If inflation is high, both parties will receive a larger amount from the share value “SV” but if inflation is low, they will receive a lower amount.

Both Lender and Borrower have an interest in the house appreciation. Their interests (or profits) are not competing as under conventional fixed vs. ARM loans, but equally aligned through shares distribution.

### BRIEF DESCRIPTION OF THE FIGURES

FIG. 1A-E shows a table of Loan Values for Example 1 of the Preferred Embodiment.

FIG. 2 shows a chart showing the relative ownership of a real property for Example 1 of the Preferred Embodiment as the loan is paid off.

### DETAILED DESCRIPTION

The invention is best described with reference to the enclosed figures and the following example.

The invention is to a program and method of recasting a loan for an asset such as a real estate holding, such as a house, building, land, etc. To maximize profit to the parties, namely the borrower and the lender, instead of providing a debt based instrument such as a mortgage loan, an equity arrangement is described that defines the interests of the borrower and the lender in a real estate asset or the like.

The equity program calculates the monthly payments, the “interest” or profits-substitute payments, the penalty shares, and the downpayment which will protect the buyer and the lender, and maximize profits to the parties. Using the following example, the profits and liabilities of the parties are described whether the money is paid back to the lender, and the risk in strong or weak economies.

Assumptions:

a—3% is the yearly inflation and/or 5% +− is the property yearly appreciation; that equals a total of 8% +−.

b—The value of one share“SV” is equal to a fixed amount “Rb”.

c—At year 10, the future value of one share have increased to 118% +−.

d—If the borrower cannot make a monthly payment, then instead of the lender charging the borrower an accumulated interest on his payment which could reach 5 to 20% extra amount on his monthly payment (PI) on borrowed money, the lender purchases back the borrower's shares (from the borrower) at the original shares Price which is agreed to up front; and the lender still makes more Profit from the shares future value rather than from interest accumulation. Current appraisal at year 10 may be needed to assure the increased property value and the share value).

e—If the borrower decides to sell his property at a new market value price, the sale price should be split between the borrower and the lender based on the number of shares owned by each one of them.

f—Banks, investors and Lenders usually monitor the economic cycle very carefully as well as verifying the borrower's industry and the Real Estate industry before making any lending decision.

### EXAMPLE 1

### Using the Above Assumptions

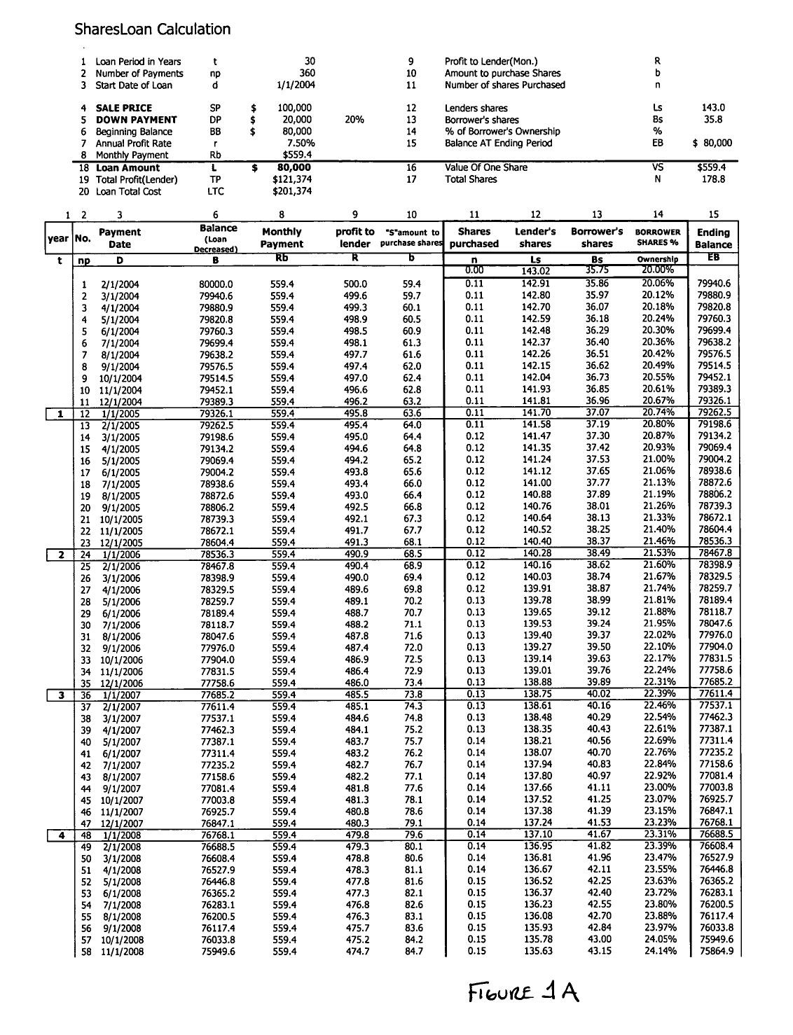

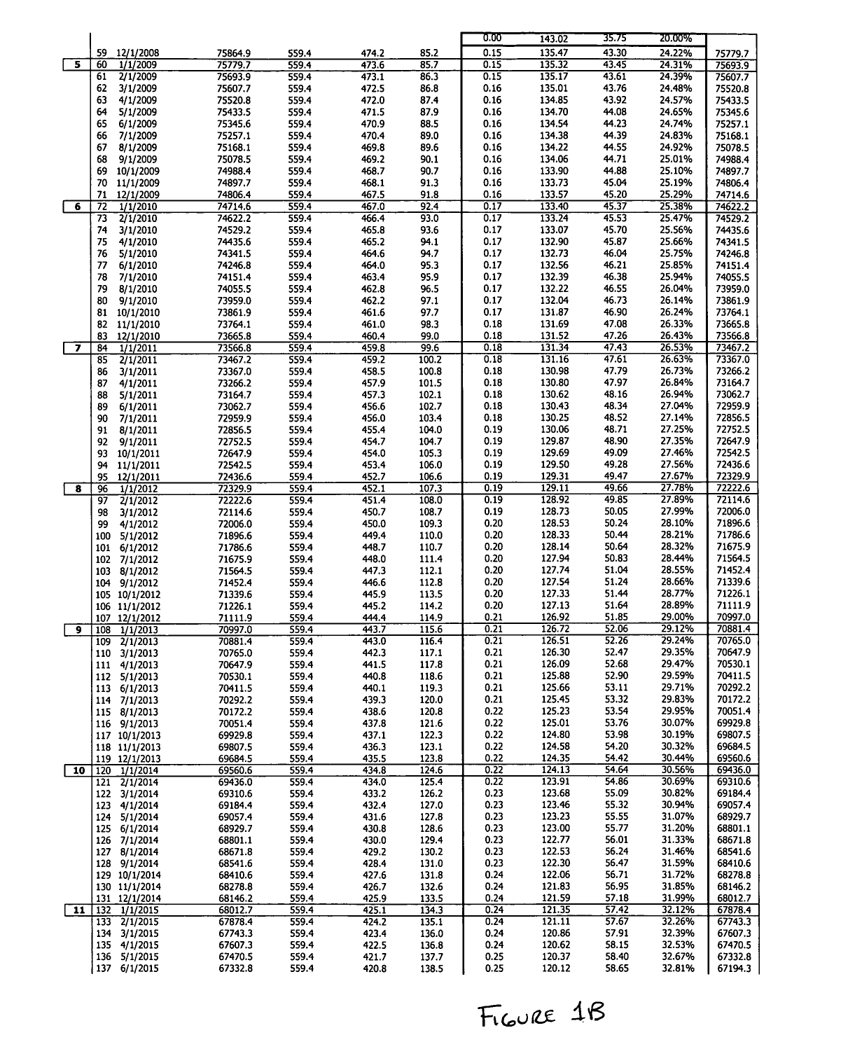

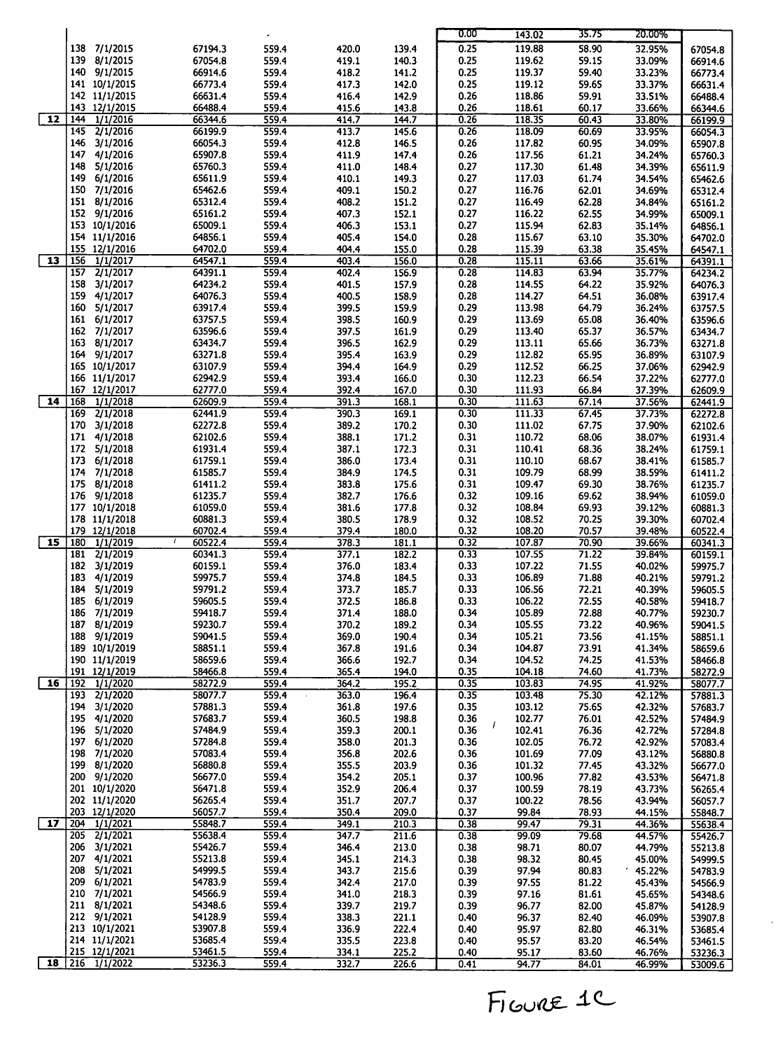

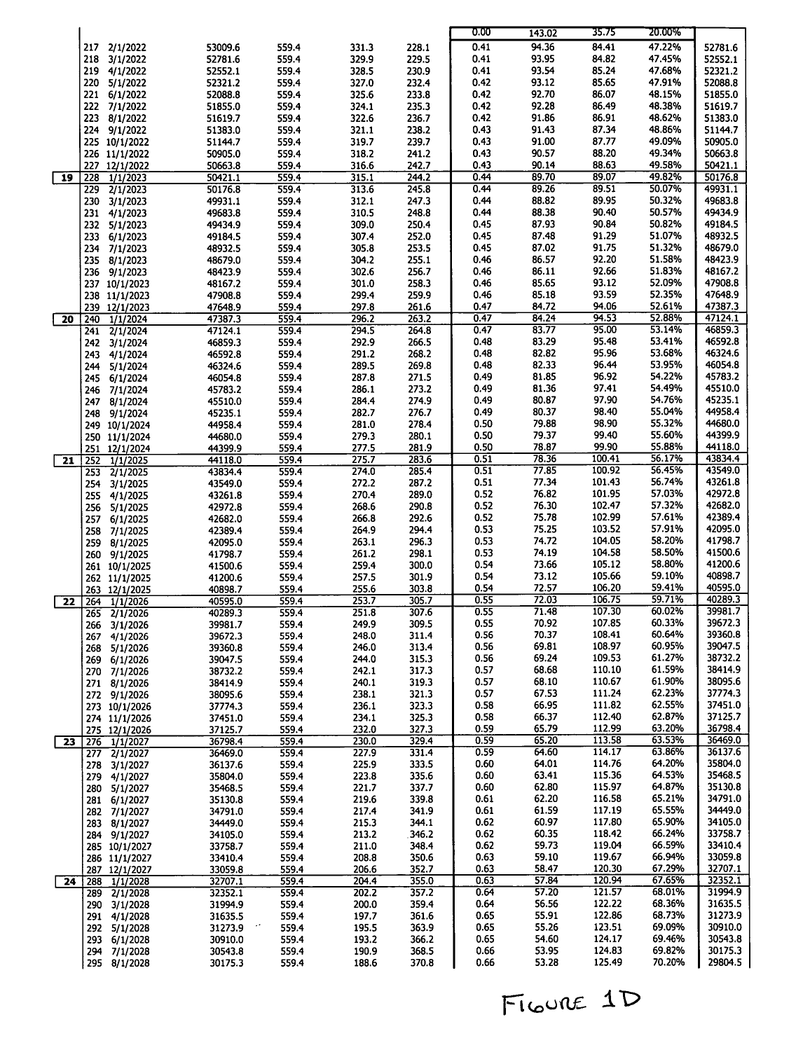

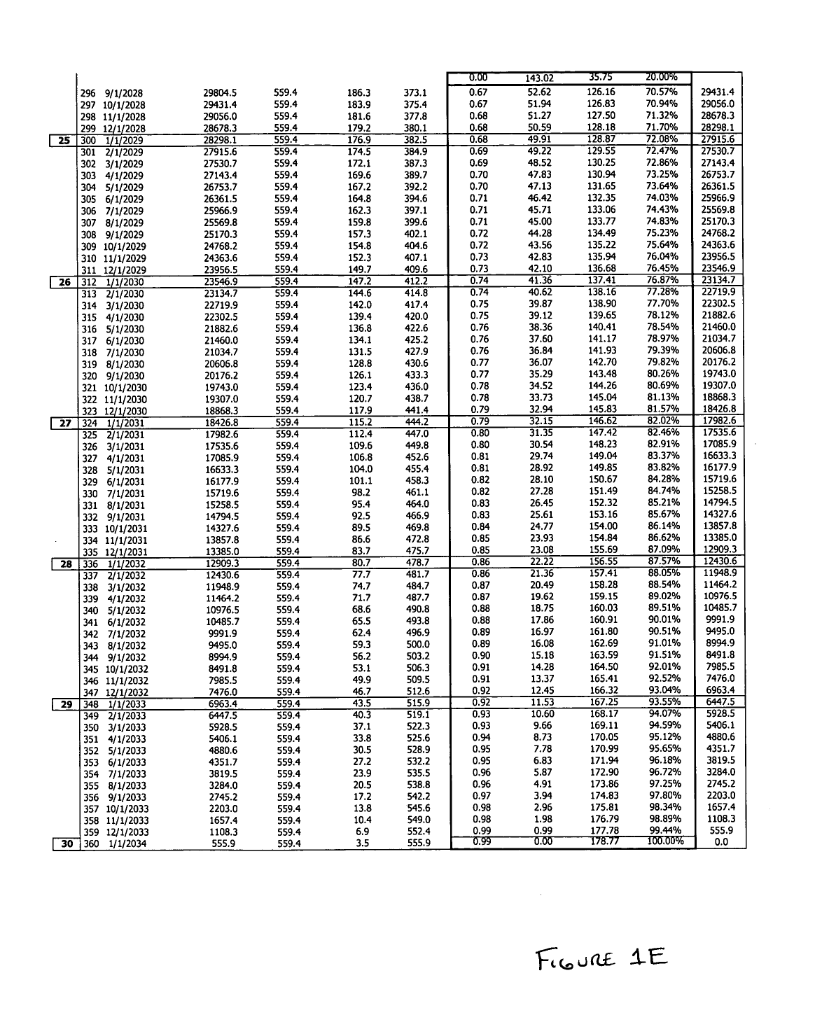

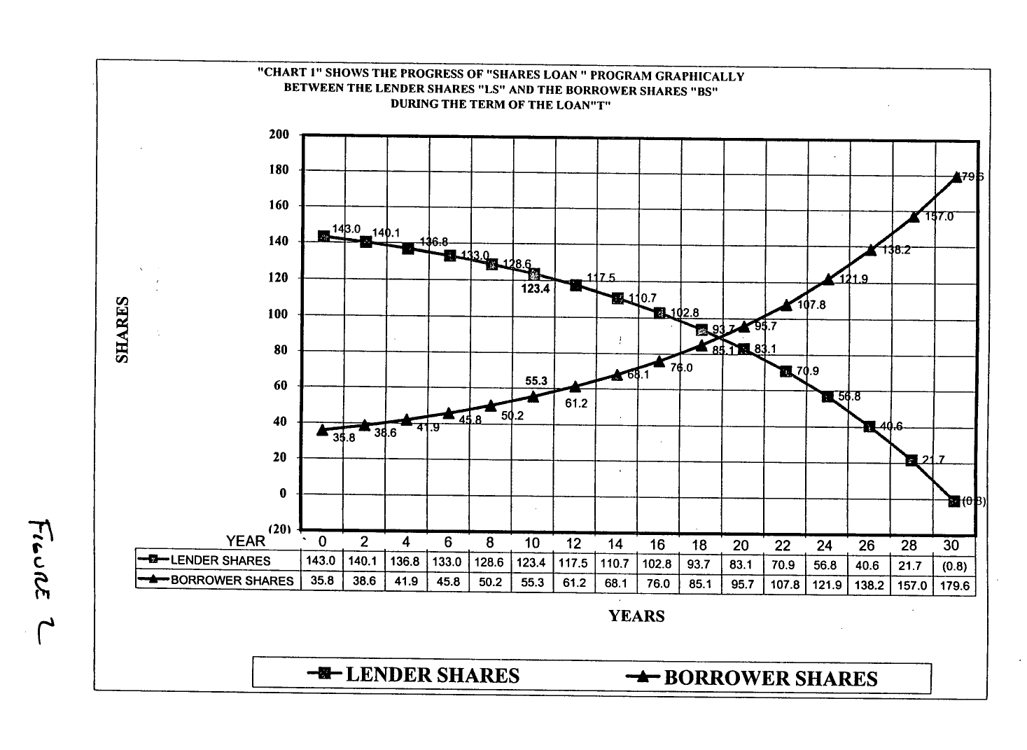

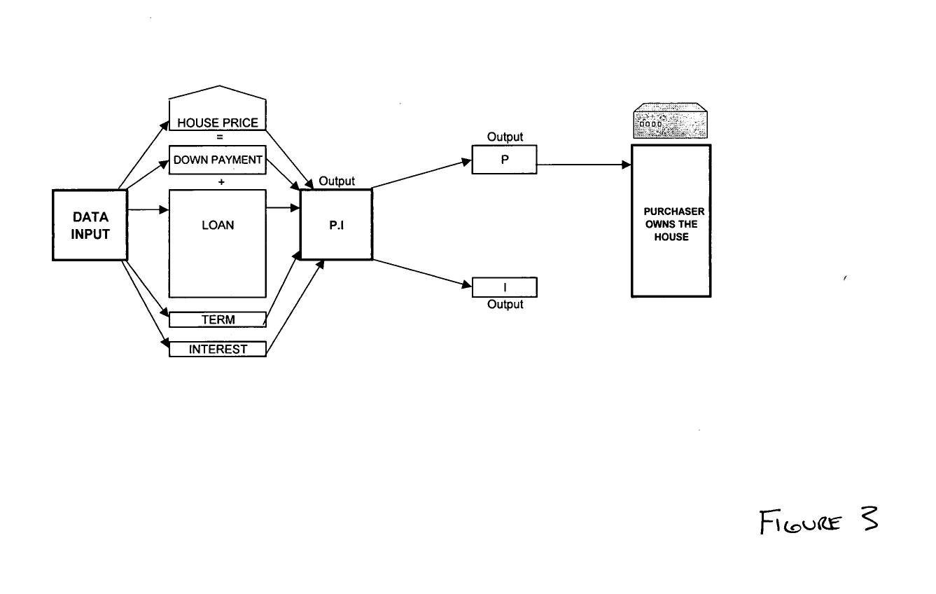

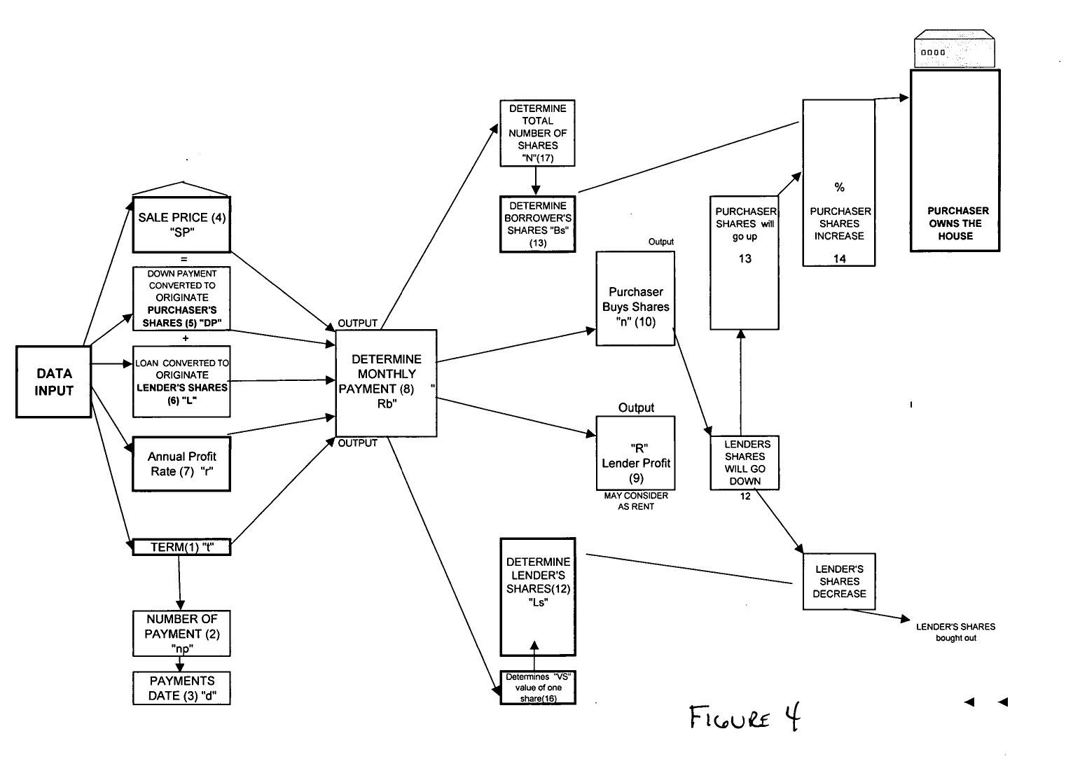

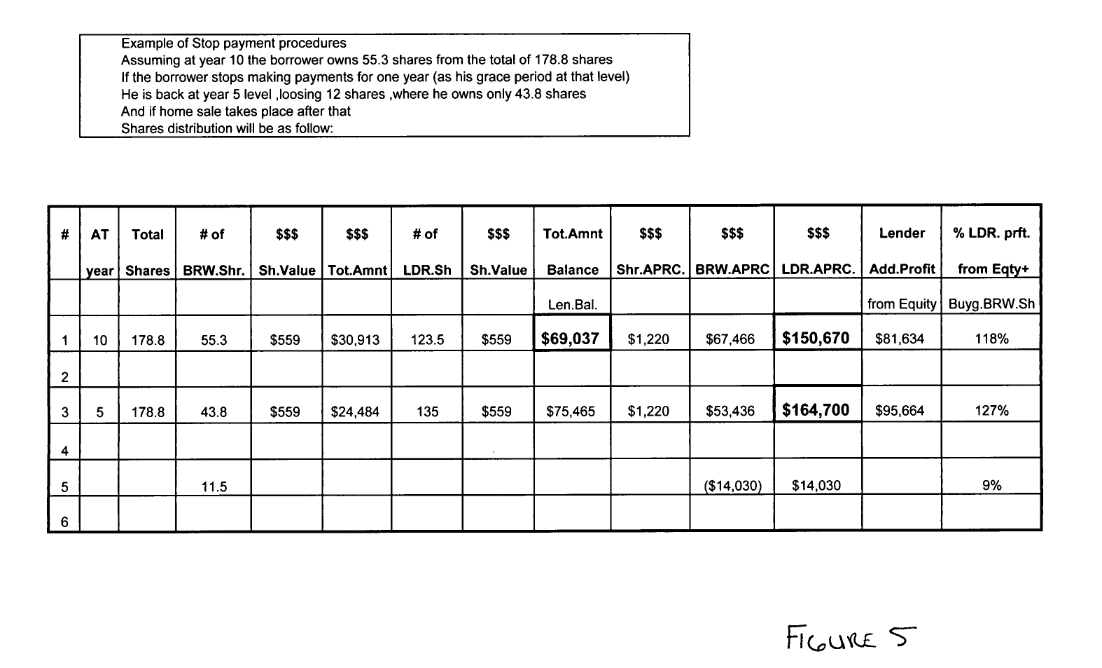

As shown in FIGS. 1A-C and 2

1—If the property sale price is equal to $100,000=“SP”

b—And the borrower's Down Payment “DP” is 20%. Equal to $ 20,000.

c—And the lender approves an $80,000 loan “L” to the borrower for “t”=30 years at an “r”=8% profit annual rate.

d—Then the value of one share “SV” equals to $559.

e—The total number of shares “N” equals the property sale price's” divided by “SV”, which is 178.8 shares=“N”.

f—The monthly payment “Rb” where “R” equals the amount of monthly profit to the Lender on his investment capital and “b” is equal to the monthly borrower's amount to purchase “n” shares from the Lender at a portion of the SV, n=b/SV.

At Year 10:

Case # 1: If the borrower decides to sell his home:

a—Suppose the economy inflation rate is about 3% per year and the property Appreciation is about 5% yearly (equity build up), a total of 8%.

b—The property sale's price is equal to $222,000 approximately, updated appraisal may be beneficial to both parties.

c—Then the value of one share increases from $559 to a future value equals to $1220=$222,000: 178.8 shares.

d—One share ($559) makes profit of $ 661=118%.

e—The balance of the lender's shares are 123.4, multiplied by $1220=$150,548.

f—Compared to the balance of conventional loan=$ 69,054

g—The lender can make additional profit of $81,494=118%.

h—The borrower owns 58.17 shares, multiplied by $1220=$70,967=118% profit

I—The equity here is divided proportionally

Case # 2: If the borrower stops making payment for any reason, and under the Same market condition above (a, d, c, d, e, and f, h):

j—The Lender shares' balance is 123.4 and the borrower shares' balance is owns 58.17 shares.

k—The share value is equal to $1220 which means each share makes a profit of $ 661=118% (this is not an accumulated interest, this is a profit).

l—The lender as a partner will purchase back shares from the borrower shares at the original share's price which is agreed to from the outset, to some extent depending on the grace period agreed to from the outset between the Lender and the borrower.

m—Selling the home (in the grace period—within the security level, which is the number of share agreed to from the outset) might be the borrower's decision to avoid any additional loss for the benefit of both parties.

Case # 3 : If the borrower used all his security shares in the allowable grace period and he reaches the penalty level. (In addition to the case #2 above)

n—The lender will collect the borrower's penalty shares as agreed from the outset and he owns the total shares of the property.

o—The property will now be completely the lender's, the decision (e.g., to sell, etc.) will be fully determined by the lender.

p—If a loss still occurs from the final sale, it should be limited to the penalty shares, no further liability to the borrower.

Case # 4: If the property does not appreciate extra 5% but only it appreciates by 3% which is still equal the inflation rate of 3% approximately.

q—No equity built up occurs but.

r—The total shares value still equals the conventional loan balance and

s—The lender can still use the penalty shares of the borrower to make up any potential loss.

As shown above, the “invention” is a managing system for a loan repayment based on shares in the field of the finance industry.

In this invention, a property Sale Price “SP” is converted into a specific number of shares and distributed proportionally between the lender and the borrower during the loan term based on their original (and continuing) contribution as partner/joint investors.

The borrower periodical payment “Rb” (monthly, semi-monthly . . . ) is composed of two payments:

One goes toward “b” principal payment to purchase shares from the lender's shares “Ls”.

Second, goes toward “R” profit payment to the lender on his capital invested.

And when the borrower affordability weakens, the lender can purchase back shares from the borrower's shares “Bs” at the original price of the share.

This invention allows the lender to extend his profit beyond the interest on the Loan ONLY to EQUITY sharing benefit with the borrower's equity as joint partners.

The invention protects the lender from interest rate fluctuation during the loan term.

The invention always encourages the borrower to put more money toward his property as a secure investment and let him enjoys the low monthly fixed payment

On the other hand an advantage of this invention is to release the borrower during his life's difficult events such as divorce, business loss, change of career, job transfer, decrease income, unexpected additional expenses and so on . . . from additional loss or damage and limits the borrower liability only to the penalty shares that were agreed to with the lender from the outset.

In this invention all kinds of safety precautions may be taken as any conventional loan programs, to secure both parties: the lender and the borrower.

The lender has all the rights to structure the loan and all its related elements, based on what he believes is needed to protect his investment and investors, such as setting the amount of the down payment, terms, profit rates, etc.

The profit to the lender investment can be paid from the borrower toward allowing the borrower to occupy and use the property, and then both the lender and the borrower are sharing the risk of gain and loss.

The program focuses on agreeable grace period between the lender and the borrower from the outset.

The program focuses on limiting the borrower liability and avoids any unknown, hidden or undisclosed potential penalty.

Goals of the Invention:

The financial industry is constantly facing new challenges in an era of very competitive markets that change instantly.

This new invention is a secure system, has the flexibility to maximize the profit and minimize the risk for parties, the lender and the borrower and fill out the gap between their sides.

This invention simply differentiates from other existing programs for many reasons such as:

The invention insulates the borrower from current interest rate fluctuation.

The invention stabilizes the properties financing market.

The borrower has the freedom to sell or refinance his home at anytime and to allow the termination of the agreement with full respect to the lender's rights. The sale price is compared with the outstanding principal obligations (shares) at the time of sale.

This invention permits the extension of the lender benefits beyond the interest amount only to equity sharing based on his shares portion.

The invention fulfills exactly all kind of the required conditions and procedures existing in conventional/ARM loans but it has “more benefits and less Risk” for both the lender and the borrower.

The invention adjusts the situation of the borrower from being in the borrowing position to being in the investing partnership position, as he is a shareholder.

TABLE 2
ABBREVIATIONS

| Number | Symbol | Definition |
|---|---|---|
| 1 | t | NUMBER OF YEARS. |
| 2 | np | NUMBER OF PAYMENT. |
| 3 | D | DATES OF PAYMENTS. |
| 4 | SP | SALE PRICE (OF THE HOUSE). |
| 5 | DP | DOWN PAYMENT AMOUNT. |
| 6 | BB | BALANCE AT BEGINNING POINT OF TIME |
| 7 | r | PROFIT ANNUAL RATE. |
| 8 | Rb | AMOUNT OF MONTHLY PAYMENT. |
| 9 | R | PROFIT TO LENDERS (MONTHLY/ |
| | | PERIODICALLY) |
| 10 | b | BORROWER'S AMOUNT “a” (PAYMENT TO |
| | | BUY SHARES) |
| 11 | n | NUMBER OF SHARES BOUGHT IN EACH |
| | | PAYMENT (PERIOD) |
| 12 | Ls | LENDER'S SHARES AVAILABLE TO SELL |
| 13 | Bs | NUMBER OF THE BORROWER'S SHARES |
| | | BOUGHT (PERIODICALLY) |
| 14 | % | PERCENTAGE OF BORROWER OWNERSHIP |
| 15 | EB | ENDING BALANCE |
| 16 | VS | VALUE OF ONE SHARE |
| 17 | N | TOTAL NUMBER OF SHARES |
| 18 | L | LOAN AMOUNT |
| 19 | TP | TOTAL PROFIT TO LENDER'S |
| 20 | LTC | LOAN TOTAL COST |

1. A method of calculating mortgage payment terms on a real property between a borrower and a lender, comprising:
inputting or receiving parameters for a mortgage, including:
a total amount of the loan from the lender or property purchase price,
a total down payment amount from the borrower, where the down payment plus the loan amount is equal to the property purchase price;
the number of periods or total duration for repayment for the mortgage, where the total duration of the loan is equal to the number of periods times the length of one period; and
an annual rate of return on the mortgage;
calculating a mortgage periodic payment amount for one said period based on the inputted parameters as the sum of a periodic interest amount and a periodic principal repayment amount;
equating the value of one share to the periodic payment amount;
calculating the total number of shares to be issued, such that the property purchase price is equal to the total number of share multiplied by the value of said one share.

2. The method of calculating mortgage payment terms on a real property between a borrower and a lender according to claim 1, further comprising amortizing a loan at one said share per one said period.

3. The method of calculating mortgage payment terms on a real property between a borrower and a lender according to claim 1, further comprising creating an amortization table of shares based on amortization of the loan by payment of one said share per one said period.

4. The method of calculating mortgage payment terms on a real property between a borrower and a lender according to claim 1, further comprising:
calculating a lender's share balance as equal to the total amount of the loan minus the number of period payments paid by the borrower.

5. The method of calculating mortgage payment terms on a real property between a borrower and a lender according to claim 1, further comprising:
calculating a lender's share balance as equal to the total amount of the loan minus the number of said shares purchased by the borrower at said share value.

6. The method of calculating mortgage payment terms on a real property between a borrower and a lender according to claim 1, further comprising calculating the borrower's share balance as equal to the total amount of the borrower's down payment divided by the value of one said share.

7. The method of calculating mortgage payment terms on a real property between a borrower and a lender according to claim 1, further comprising calculating the remaining amount of the loan as the total amount of the loan from the lender reduced by the number of shares purchased by the borrower times said periodic principal repayment amount.

8. The method of calculating mortgage payment terms on a real property between a borrower and a lender according to claim 1, further comprising calculating the remaining amount of the loan as the total amount of the loan from the lender increased by the number of shares purchased by the lender times said periodic principal repayment amount.

9. The method of calculating mortgage payment terms on a real property between a borrower and a lender according to claim 5, further comprising calculating the percentage equity ownership of the lender by dividing the lender's share balance by the total number of shares.

10. The method of calculating mortgage payment terms on a real property between a borrower and a lender according to claim 6, further comprising dividing said borrower's shares into a preselected number of penalty shares, wherein the maximum financial penalty that can be imposed by the lender for the borrower defaulting on the loan is equal to the number of penalty shares times the value of one said share.

11. The method of calculating mortgage payment terms on a real property between a borrower and a lender according to claim 6, wherein for each mortgage periodic payment, the periodic interest amount is paid as profit to the lender, and the periodic principal repayment amount is used to repurchase shares for the lender.

12. The method of calculating mortgage payment terms on a real property between a borrower and a lender according to claim 11, wherein the periodic principal repayment amount is less than the value of one said share.

13. In a financial management system for calculating a loan repayment amortized through period installments paid by a borrower to a lender based on an annual rate of return over a preselected number of periods, comprising:
means for inputting a total sales price for a property bought using the proceeds of said loan;
means for converting the repayment over said period into a periodic payment to be paid in each periodic installment;
means for calculating the number of lender shares as equal to the amount of said loan divided by the periodic payment amount;
means for calculating the number of borrower shares as equal to the amount of said down payment divided by the periodic payment amount;
means for calculating the total number of shares as the total number of said borrower shares plus the total number of said lender shares.

14. The system of claim 10, further comprising means for calculating one share as equal to the amount of one said period payment.

15. The system of claim 10, further comprising means for creating an amortization table of shares based on amortization of the loan by payment of one said share per one said period.

16. The system of claim 10, further comprising means for calculating the borrower's share balance as equal to the total amount of the borrower's down payment divided by the value of one said share.

17. The method of calculating mortgage payment terms on a real property between a borrower and a lender according to claim 5, further comprising calculating the percentage equity ownership of the lender by dividing the lender's share balance by the total number of shares.
